(19) United States
(12) Patent Application Publication
(10) Pub. No.: US 2014/0192008 A1
(43) Pub. Date: Jul. 10, 2014

(54) TOUCH ACQUISITION IN A PROJECTED CAPACITIVE TOUCH SCREEN SYSTEM

(71) Applicants: STMICROELECTRONICS K.K., Tokyo (JP); STMICROELECTRONICS (ROUSSET) SAS, Rousset (FR)

(72) Inventors: Maxime Teissier, Tokyo (JP); Cyril Troise, Marseille (FR)

(73) Assignees: STMICROELECTRONICS (ROUSSET) SAS, Rousset (FR); STMICROELECTRONICS K.K., Tokyo (JP)

(21) Appl. No.: 13/736,164

(22) Filed: Jan. 8, 2013

(51) Int. Cl. G06F 3/044

(52) U.S. Cl. CPC G06F 3/044
USPC 345/174

(57) ABSTRACT

A capacitive touch panel includes first electrodes extending in first direction and second electrodes extending in a second (intersecting) direction. The first electrodes include parallel extending transmit first electrodes and receive first electrodes that are interleaved with each other. The second electrodes include parallel extending transmit second electrodes and receive second electrodes that are interleaved with each other. Transmit circuitry is coupled to the transmit first electrodes and transmit second electrodes. Receive circuitry coupled to the receive first electrodes and receive second electrodes. Processing circuitry controls activation of the transmit and receive circuitry in a manner which supports the making of adjacent line capacitance measurements and intersecting line capacitance measurements. The capacitance measurements are processed to identify and determine location of touches made on or near the capacitive touch panel.

### TECHNICAL FIELD

The present invention relates to a capacitive touch screen technology and, in particular, to method and apparatus for improving acquisition speed in a projected capacitive touch screen using parallel transmit and receive electrodes.

### BACKGROUND

Touch screens are common technologies in today's electronic devices. There are three common touch screen configurations: resistive touch screens, surface capacitive touch screens and projected capacitive touch screens.

Reference is now made to FIG. 1 which illustrates a conventional projected capacitive touch screen system 10. The system 10 includes a touch screen panel 20 and a touch screen circuit 30. The touch screen panel 20 supports a layout of electrodes. The electrodes include a plurality of first electrodes 22 extending in a first direction (for example, a vertical direction) and a plurality of second electrodes 24 extending in a second direction (for example, a horizontal direction) such that the first electrodes and second electrodes cross each other at intersection locations 26. The plurality of first electrodes 22 are provided on a first layer of the touch screen panel 20 and the plurality of second electrodes 24 are provided on a second layer of the touch screen panel. The first and second layers of the touch screen panel 20 are separated from each other by an insulating layer (not explicitly shown), and thus a capacitance is formed at each intersection location 26 between one first electrode 22 and one second electrode 24. The touch screen panel 20 may further include, in a manner understood by those skilled in the art, a number of other supporting and protecting layers.

The touch screen processing circuit 30 includes a plurality of transmit drive circuits 32 and a plurality of receive sense circuits 34. The outputs of the transmit drive circuits 32 are coupled to the plurality of first electrodes 22, while the inputs of the receive sense circuits 34 are coupled to the plurality of second electrodes 24. Sensing of the touch screen panel 20 is performed under the control of the processing circuit 30 by scanning the intersection locations 26 to sense capacitance. This is accomplished by activating one of the transmit drive circuits 32 and one of the receive sense circuits 34 whose corresponding first electrode 22 and second electrode 24 intersect at the desired location 26 to be scanned. The sensed capacitance at each location 26 is varied under the influence of a touch made to (or near) the panel 20. The scanning operation is repeated for each location 26 within the panel 20. Thus, it will be understood that a total of X·Y scanning operations must be performed in order to completely scan all intersection locations 26 of the touch screen panel 20 (where X is the number of column electrodes and Y is the number of row electrodes).

An example of a suitable touch screen processing circuit 30 for use with a projected capacitive touch screen panel 20 is the STM8T family of microcontrollers produced by STMicroelectronics, for example, the STM8TL53 microcontroller. This microcontroller includes, for example, up to fifteen transmit drive circuits 32 (transmit channels) and up to twenty receive sense circuits 34 (receive channels).

The scanning operation performed by the touch screen processing circuit 30 permits the resolution of multiple simultaneous touches being made to the panel 20 along the an identification of the X and Y coordinates of each touch.

As touch screen panels increase in size, the length of the first electrodes 22 and second electrodes 24 also increases. With increased electrode length, there is a corresponding increase in electrode resistivity. The increase in electrode resistivity produces an increase in the RC time constant of the drive and sense circuit, and the increased RC time constant results in an increase in the acquisition time for each scan of an intersection location 26. Still further, with increased sized touch screen panels there is an increase in the number of first electrodes 22 and second electrodes 24 that are needed, and thus the number of intersection locations 26 to be scanned also increases. The increased acquisition time for each location scan is magnified by the increased number of scanned locations resulting in an unacceptable scanning operation for the projected capacitive touch screen system.

Reference is now made to FIG. 2 which illustrates a conventional surface capacitive touch screen system 50. The system 50 includes a touch screen panel 60 and a touch screen processing circuit 70. The touch screen panel 60 supports a layout of electrodes. The electrodes include a plurality of first electrodes 62 extending in a first direction (for example, a vertical direction) and a plurality of second electrodes 64 extending in a second direction (for example, a horizontal direction). The electrodes 62 and 64 are provided on one or more layers of the touch screen panel 60. A transparent electroconductive layer (not explicitly shown) is provided over the first layer.

The touch screen processing circuit 70 includes a plurality of sensing circuits 72, each having a node coupled to one of the electrodes 62 and 64. Each sensing circuit generates an AC sensing signal (for example, an AC square wave or sinusoidal voltage signal) which is applied to the electrodes 62 and 64. Current flowing in the electrodes 62 and 64 as a result of the applied AC sensing signals is varied under the influence of a touch made to the surface of the panel 60. Ground return for the signals is made through the earth or body of the person touching the panel. A resulting change in capacitance is sensed by the sensing circuits 72 and resolved to calculate the X and Y coordinates of the touch. In order to scan the entire panel, X+Y sensing acquisitions must be made (where X is the number of column electrodes and Y is the number of row electrodes) by the circuits 72. This is significantly less than the X·Y scanning operations that must be performed in the projected capacitive system of FIG. 1, and thus the acquisition time in the surface capacitive touch screen system is relatively quick even with significantly large panel sizes.

It is accordingly common to use projected capacitive touch screen systems in mobile applications such as cellular telephones where the panel size is relatively small. It is also common to use surface capacitive touch screen systems in fixed applications such as computer interactive graphical user interface displays of larger size.

There would be an advantage if projected capacitive touch screen systems could be configured to provide a surface capacitive-like acquisition at least in terms of acquisition time thus enabling projected capacitive touch screen panels and processing circuits to be used in connection with larger sized panels.

### SUMMARY

In an embodiment, an apparatus comprises: a capacitive touch panel including a plurality of first electrodes extending in first direction and a plurality of second electrodes extending in a second direction, the first and second electrodes intersecting each other; wherein the plurality of first electrodes includes transmit first electrodes and receive first electrodes, the transmit first electrodes and receive first electrodes being interleaved; wherein the plurality of second electrodes includes transmit second electrodes and receive second electrodes, the transmit second electrodes and receive second electrodes being interleaved; transmit circuitry coupled to the transmit first electrodes and transmit second electrodes; and receive circuitry coupled to the receive first electrodes and receive second electrodes.

In an embodiment, a method, comprises: controlling operation of a capacitive touch panel including a plurality of first electrodes extending in first direction and a plurality of second electrodes extending in a second direction, the first and second electrodes intersecting each other; wherein the plurality of first electrodes includes transmit first electrodes and receive first electrodes, the transmit first electrodes and receive first electrodes being interleaved; wherein the plurality of second electrodes includes transmit second electrodes and receive second electrodes, the transmit second electrodes and receive second electrodes being interleaved; wherein controlling comprises: activating transmit circuitry coupled to the transmit first electrodes and transmit second electrodes; and activating receive circuitry coupled to the receive first electrodes and receive second electrodes.

In an embodiment, a capacitive touch panel includes: first electrodes extending in first direction; second electrodes extending in a second (intersecting) direction; wherein the first electrodes include parallel extending transmit first electrodes and receive first electrodes that are interleaved with each other; wherein the second electrodes include parallel extending transmit second electrodes and receive second electrodes that are interleaved with each other; transmit circuitry coupled to the transmit first electrodes and transmit second electrodes; receive circuitry coupled to the receive first electrodes and receive second electrodes; and processing circuitry which controls activation of the transmit and receive circuitry in a manner which supports the making of adjacent line capacitance measurements and intersecting line capacitance measurements and the processing of the capacitance measurements to identify and determine location of touches made on or near the capacitive touch panel.

### BRIEF DESCRIPTION OF THE DRAWINGS

For a better understanding of the embodiments, reference will now be made by way of example only to the accompanying figures in which:

FIG. 1 illustrates a conventional projected capacitive touch screen system;

FIG. 2 illustrates a conventional surface capacitive touch screen system;

FIG. 3 illustrates an embodiment of a projected capacitive touch screen system;

FIGS. 4A-4D illustrate a process for scanning performed by the system of FIG. 3;

FIGS. 5A and 5B illustrate single touch and multi-touch scenarios for the scanning process;

FIG. 6 illustrates an embodiment of a projected capacitive touch screen system;

FIGS. 7A-4F illustrate a process for scanning performed by the system of FIG. 6; and

FIGS. 8A and 8B illustrate single touch and multi-touch scenarios for the scanning process.

### DETAILED DESCRIPTION OF THE DRAWINGS

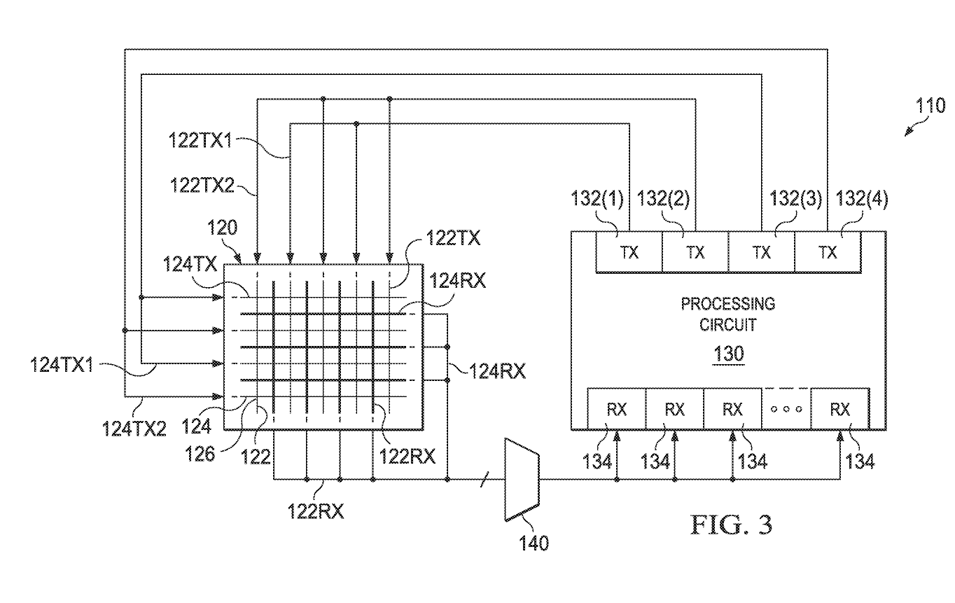

Reference is now made to FIG. 3 which illustrates an embodiment of a projected capacitive touch screen system 110. The system 110 includes a touch screen panel 120 and a touch screen processing circuit 130. The touch screen panel 120 supports a layout of electrodes. The electrodes include a plurality of first electrodes 122 extending in a first direction (for example, a vertical direction) and a plurality of second electrodes 124 extending in a second direction (for example, a horizontal direction) such that the first electrodes and second electrodes cross each other at intersection locations 126. The plurality of first electrodes 122 are provided on a first layer of the touch screen panel 120 and the plurality of second electrodes 124 are provided on a second layer of the touch screen panel. The first and second layers of the touch screen panel 120 are separated from each other by an insulating layer (not explicitly shown), and thus a capacitance is formed at each intersection location 126 between on first electrode 122 and one second electrode 124. The touch screen 120 panel may further include, in a manner understood by those skilled in the art, a number of other supporting and protecting layers.

The plurality of first electrodes 122 are divided into a plurality of transmit (TX) first electrodes 122TX and a plurality of receive (RX) first electrodes 122RX. The transmit (TX) first electrodes 122TX and receive (RX) first electrodes 122RX extend in the first direction (for example, the vertical direction) parallel to each other. The transmit (TX) first electrodes 122TX and receive (RX) first electrodes 122RX are interleaved such that, except for end electrodes, each receive (RX) first electrodes 122RX is positioned between a pair of transmit (TX) first electrodes 122TX and each transmit (TX) first electrode 122TX is positioned between a pair of receive (RX) first electrodes 122RX, and thus a column capacitance is also formed between adjacent first electrodes 122.

The plurality of second electrodes 124 are divided into a plurality of transmit (TX) second electrodes 124TX and a plurality of receive (RX) second electrodes 124RX. The transmit (TX) second electrodes 124TX and receive (RX) second electrodes 124RX extend in the second direction (for example, the horizontal direction) parallel to each other. The transmit (TX) second electrodes 124TX and receive (RX) second electrodes 124RX are interleaved such that, except for end electrodes, each receive (RX) second electrodes 124RX is positioned between a pair of transmit (TX) second electrodes 124TX and each transmit (TX) second electrode 124TX is positioned between a pair of receive (RX) second electrodes 124RX, and thus a row capacitance is also formed between adjacent second electrodes 124.

The touch screen processing circuit 130 includes a plurality of transmit drive circuits 132 and a plurality of receive sense circuits 134. The outputs of the transmit drive circuits 132 are coupled to the transmit (TX) first electrodes 122TX and transmit (TX) second electrodes 124TX, while the inputs of the receive sense circuits 134 are coupled to the receive (RX) first electrodes 122RX and receive (RX) second electrodes 124RX. Sensing of the touch screen panel 120 is performed under the control of the processing circuit 130 by scanning rows and columns of the panel 120 to sense capacitance. This is accomplished by activating one of the transmit drive circuits 132 and one of the receive sense circuits 134 whose corresponding transmit electrode and receive electrode, respectively, are positioned adjacent to each other in the panel 120. The sensed capacitance between the adjacent electrodes in a row or column (i.e., the adjacent line capacitance) is varied under the influence of a touch made to (or near) the panel 120. The scanning operation is repeated as needed such that each row and column is scanned within the panel 120, and the sensed capacitance values are resolved to calculate the X and Y coordinates of the touch.

The plurality of transmit (TX) first electrodes 122TX are divided into sub-groups each containing a plurality of first electrodes 122. For example, two sub-groups may be defined as a first sub-group of transmit (TX) first electrodes 122TX1 and a second sub-group of transmit (TX) first electrodes 122TX2.

The plurality of transmit (TX) second electrodes 124TX are divided into sub-groups each containing a plurality of second electrodes 124. For example, two sub-groups may be defined as a first sub-group of transmit (TX) second electrodes 124TX1 and a second sub-group of transmit (TX) second electrodes 124TX2.

In a preferred implementation, the transmit electrodes in a given sub-group are coupled to the outputs of a common transmit drive circuit 132. Thus, in accordance with the example, the electrodes in the first sub-group of transmit (TX) first electrodes 122TX1 are all group coupled to the output of a first transmit drive circuit 132(1). The electrodes of the second sub-group of transmit (TX) first electrodes 122TX2 are all group coupled to the output of a second transmit drive circuit 132(2). The electrodes of the first sub-group of transmit (TX) second electrodes 124TX1 are all group coupled to the output of a third transmit drive circuit 132(3). Finally, the electrodes of the second sub-group of transmit (TX) second electrodes 124TX2 are all group coupled to the output of a fourth transmit drive circuit 132(4).

It will accordingly be understood that one-half of the transmit (TX) first electrodes 122TX are coupled to the output of the first transmit drive circuit 132(1) and the other half of the transmit (TX) first electrodes 122TX are coupled to the output of the second transmit drive circuit 132(2). Likewise, one-half of the transmit (TX) second electrodes 124TX are coupled to the output of the third transmit drive circuit 132(3) and the other half of the transmit (TX) second electrodes 124TX are coupled to the output of the fourth transmit drive circuit 132(4). The reference to “one-half” above will be understood to mean exactly one-half or approximately one-half, wherein approximately one-half occurs when there exist an odd number of rows or columns (i.e., n/2 for the one half and n/2+1 for the other half, where n is the number of rows or columns).

In a preferred implementation, the electrodes of the plurality of receive (RX) first electrodes 122RX are individually coupled to the inputs of corresponding individual ones of the plurality of receive sense circuits 134. Likewise, the electrodes of the plurality of receive (RX) second electrodes 124RX are individually coupled to the inputs of corresponding individual ones of the plurality of receive sense circuits 134. If the touch screen circuit 130 includes an insufficient number of receive sense circuits 134 to handle the unique coupling to the plurality of receive (RX) first electrodes 122RX and the plurality of receive (RX) second electrodes 124RX, a multiplexing circuit 140 (optional) can be added to allow the receive (RX) first electrodes 122RX and receive (RX) second electrodes 124RX to share a same set of receive sense circuits 134.

An example of a suitable touch screen processing circuit 130 for use with the projected capacitive touch screen panel 120 is the STM8T family of microcontrollers produced by STMicroelectronics, for example, the STM8TL53 microcontroller. This microcontroller includes a plurality of transmit drive circuits 132 (for example, up to fifteen transmit channels) and a plurality of receive sense circuits 134 (for example, up to twenty receive channels). It will further be understood that the processing circuit 130 may be formed by more than one microcontroller. For example, a first microcontroller may be used for making the column measurements and a second microcontroller may be used for making the row measurements. One or the other of the microcontrollers, or perhaps a third microcontroller or processing circuit, could be used to process the row and column measurements to calculate the X and Y coordinates of the touch.

The microcontroller circuitry for the touch screen processing circuit 130 is programmed to implement a scanning algorithm to make the row and column scans, detect adjacent line capacitances associated with such scans, and process the detected capacitances to calculate the X and Y coordinates of the touch. The scanning operation supported by the algorithm may generally be described as follows:

For column scanning, the transmit drive circuits 132 associated with each sub-group of transmit (TX) first electrodes 122TX are sequentially actuated and for each actuation in the sequence the receive sense circuits 134 for the receive (RX) first electrodes 122RX are actuated (preferably in parallel) to make column adjacent line capacitance measurements. This operation may be understood as a nested loop operation with the selection of sub-groups of transmit (TX) first electrodes 122TX being made in the outer loop and the selection of receive (RX) first electrodes 122RX being made in the inner loop.

For row scanning, the transmit drive circuits 132 associated with each sub-group of transmit (TX) second electrodes 124TX are sequentially actuated and for each actuation in the sequence the receive sense circuits 134 for the receive (RX) second electrodes 124RX are actuated (preferably in parallel) to make row adjancent capacitance measurements. This operation may be understood as a nested loop operation with the selection of sub-groups of transmit (TX) second electrodes 124TX being made in the outer loop and the selection of receive (RX) second electrodes 124RX being made in the inner loop.

The column adjacent line capacitance measurements and row adjacent line capacitance measurements are then processed to calculate the X and Y coordinates of the touch. This processing calculation operation is well known to those skilled in the art and will not be described in detail.

The column scanning operation, row scanning operation, and coordinate processing calculation may be performed by one microcontroller or by separate microcontrollers in accordance with a desired design of the processing circuit 130. The selection of the number of microcontrollers for inclusion in the processing circuit 130 may be made in response to the size of the panel 120 and the number of included column electrodes 122 and row electrodes 124.

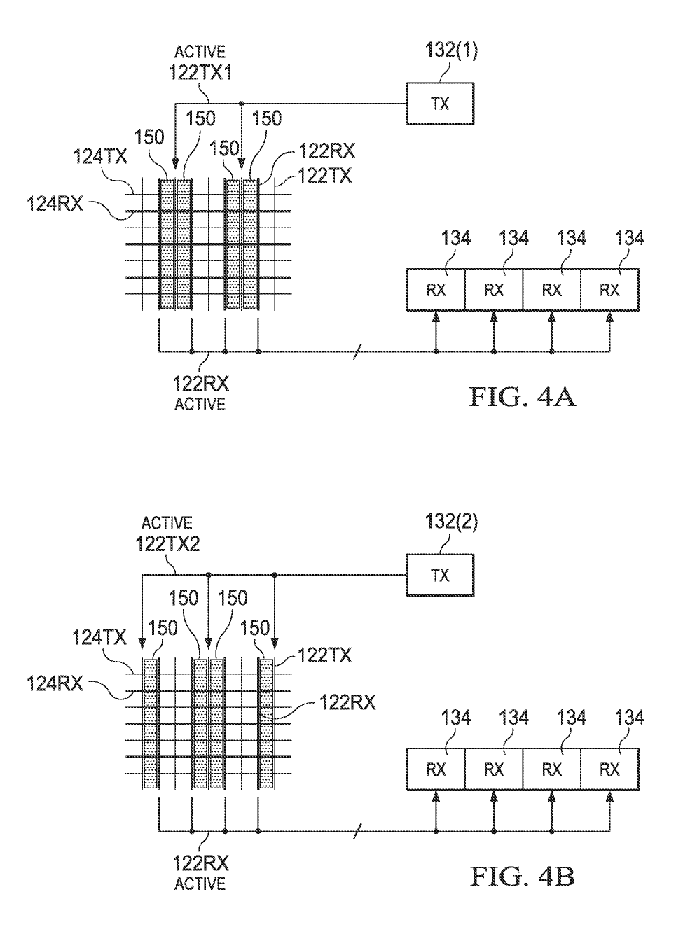

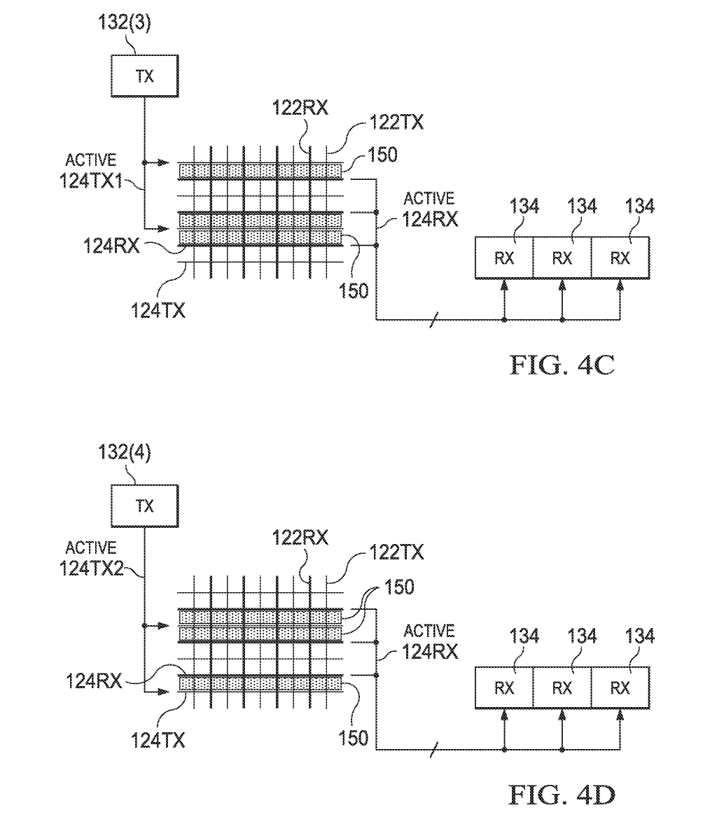

A better understanding of the scanning algorithm implemented by the processing circuit 130 may be obtained by reference to a specific example. In FIG. 4A, transmit drive circuit 132(1) is activated and the first sub-group of transmit (TX) first electrodes 122TX1 is selected. The receive sense circuits 134 for the receive (RX) first electrodes 122RX are then actuated (preferably in parallel) to make column adjacent line capacitance measurements (as indicated by the shading 150). This would accordingly comprise the making of four (surface capacitive-like) measurements. The second sub-group of transmit (TX) first electrodes 122TX2 are controlled by the processing circuit 130 to be tied to a reference voltage (for example, ground) in order to address (i.e., reduce) concerns with cross-detection. The transmit (TX) second electrodes 124TX and receive (RX) second electrodes 124RX which cross the electrodes 122 are controlled by the processing circuit 130 to be floating.

In FIG. 4B, transmit drive circuit 132(2) is activated and the second sub-group of transmit (TX) first electrodes 122TX2 is selected. The receive sense circuits 134 for the receive (RX) first electrodes 122RX are then actuated (preferably in parallel) to make column adjacent line capacitance measurements (as indicated by the shading 150). This would accordingly comprise the making of four (surface capacitive-like) measurements. The first sub-group of transmit (TX) first electrodes 122TX1 are controlled by the processing circuit 130 to be tied to a reference voltage (for example, ground) in order to address (i.e., reduce) concerns with cross-detection. The transmit (TX) second electrodes 124TX and receive (RX) second electrodes 124RX which cross the electrodes 122 are controlled by the processing circuit 130 to be floating.

In FIG. 4C, transmit drive circuit 132(3) is activated and the first sub-group of transmit (TX) second electrodes 124TX1 is selected. The receive sense circuits 134 for the receive (RX) second electrodes 124RX are then actuated (preferably in parallel) to make row adjacent line capacitance measurements (as indicated by the shading 150). This would accordingly comprise the making of three (surface capacitive-like) measurements. The second sub-group of transmit (TX) second electrodes 124TX2 are controlled by the processing circuit 130 to be tied to a reference voltage (for example, ground) in order to address (i.e., reduce) concerns with cross-detection. The transmit (TX) first electrodes 122TX and receive (RX) first electrodes 122RX which cross the electrodes 124 are controlled by the processing circuit 130 to be floating.

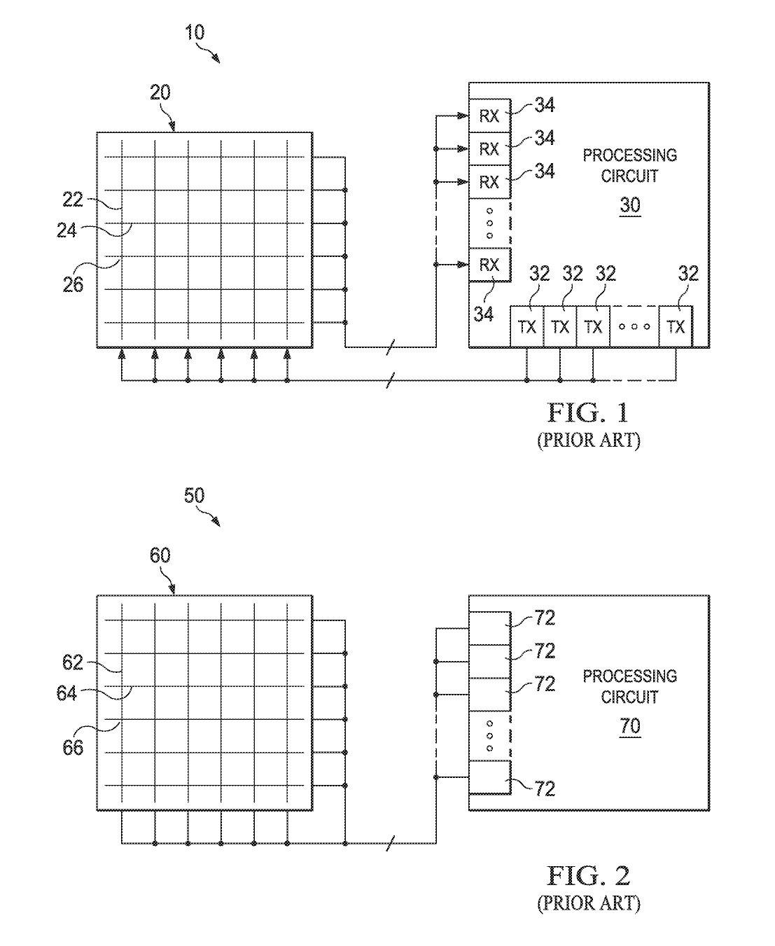

In FIG. 4D, transmit drive circuit 132(4) is activated and the second sub-group of transmit (TX) second electrodes 124TX2 is selected. The receive sense circuits 134 for the receive (RX) second electrodes 124RX are then actuated (preferably in parallel) to make row adjacent line capacitance measurements (as indicated by the shading 150). This would accordingly comprise the making of three (surface capacitive-like) measurements. The first sub-group of transmit (TX) second electrodes 124TX1 are controlled by the processing circuit 130 to be tied to a reference voltage (for example, ground) in order to address (i.e., reduce) concerns with cross-detection. The transmit (TX) first electrodes 122TX and receive (RX) first electrodes 122RX which cross the electrodes 124 are controlled by the processing circuit 130 to be floating. It will accordingly be noted that this example requires the making of (X−1)+(Y−1) sense measurements (reference 150, in this example, fourteen) to scan all rows and columns of the entire panel, which is less than the X+Y sense measurements performed by the conventional surface capacitive system of FIG. 2 and significantly less than the X·Y scanning operations performed by the conventional projected capacitive touch screen system of FIG. 1 (where X is the number of vertical electrodes 122 and Y is the number of horizontal electrodes 124). Thus, even if the size of the panel 120 is significantly large, the process illustrated in FIG. 4A-4D will provide a substantial improvement in acquisition time.

It will be understood that the operations of FIGS. 4A-4D may be performed by the processing circuit 130 in any desired order.

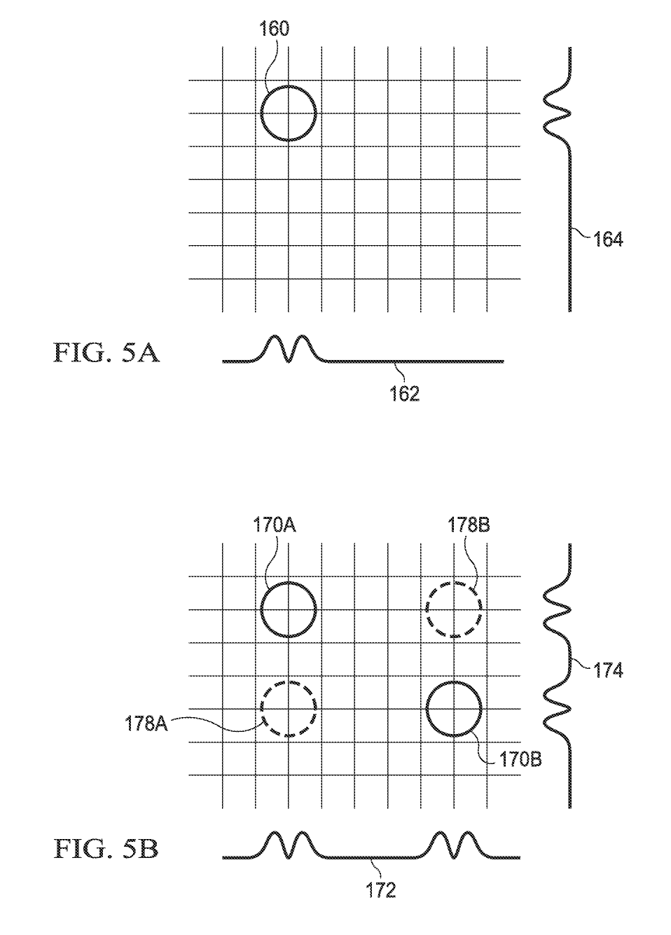

FIG. 5A illustrates a touch 160 having been made to the panel 120. The result of the column capacitance measurements of FIGS. 4A-4B is illustrated by waveform 162 which peaks along the x-axis (horizontal direction) at the surface capacitive measurements (between adjacent electrodes) associated with a size and location corresponding to the horizontal (X coordinate) of the touch 160. The result of the row capacitance measurements of FIGS. 4C-4D is illustrated by waveform 164 which peaks along the y-axis (vertical direction) at the surface capacitive measurements (between adjacent electrodes) associated with a size and location corresponding to the vertical (Y coordinate) of the touch 160. The waveforms 162 and 164 may accordingly be processed in a manner known in the art to calculate the X and Y coordinates of the touch 160.

FIG. 5B illustrates simultaneous touches 170A and 170B having been made to the panel 120. The result of the column capacitance measurements of FIGS. 4A-4B is illustrated by waveform 172 which peaks along the x-axis (horizontal direction) at the surface capacitive measurements (between adjacent electrodes) associated with a size and location corresponding to the horizontal (X coordinate) of the two touches 170A and 170B. The result of the row capacitance measurements of FIGS. 4C-4D is illustrated by waveform 174 which peaks along the y-axis (vertical direction) at the surface capacitive measurements (between adjacent electrodes) associated with a size and location corresponding to the vertical (Y coordinate) of the two touches 170A and 170B. In this situation, the waveforms 172 and 174 cannot be processed to calculate the X and Y coordinates of the two touches 170A and 170B because the multiple peaks in the waveforms 162 and 164 could alternatively indicate touches being made at ghost locations 178A and 178B. Unambiguous resolution of the X and Y coordinates of the multiple touches is not possible. It will accordingly be understood that projected capacitive touch screen system 110 of FIG. 3 is suitable only for single touch applications.

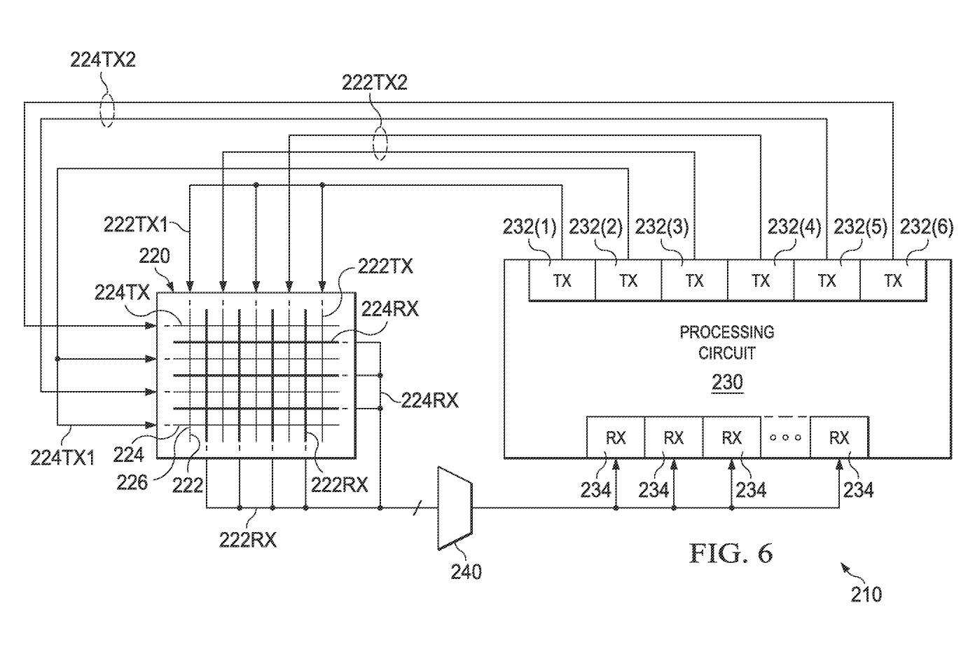

Reference is now made to FIG. 6 which illustrates an embodiment of a projected capacitive touch screen system 210. The system 210 includes a touch screen panel 220 and a touch screen circuit 230. The touch screen panel 220 supports a layout of electrodes. The electrodes include a plurality of first electrodes 222 extending in a first direction (for example, a vertical direction) and a plurality of second electrodes 224 extending in a second direction (for example, a horizontal direction) such that the first electrodes and second electrodes cross each other at intersection locations 226. The plurality of first electrodes 222 are provided on a first layer of the touch screen panel 220 and the plurality of second electrodes 224 are provided on a second layer of the touch screen panel. The first and second layers of the touch screen panel 220 are separated from each other by an insulating layer (not explicitly shown), and thus a capacitance is formed at each intersection location 226 between a first electrode 222 and second electrode 224. The touch screen panel may further include, in a manner understood by those skilled in the art, a number of other supporting and protecting layers.

The plurality of first electrodes 222 are divided into a plurality of transmit (TX) first electrodes 222TX and a plurality of receive (RX) first electrodes 222RX. The transmit (TX) first electrodes 222TX and receive (RX) first electrodes 222RX extend in the first direction (for example, the vertical direction) parallel to each other. The transmit (TX) first electrodes 222TX and receive (RX) first electrodes 222RX are interleaved such that, except for end electrodes, each receive (RX) first electrodes 222RX is positioned between a pair of transmit (TX) first electrodes 222TX and each transmit (TX) first electrode 222TX is positioned between a pair of receive (RX) first electrodes 222RX, and thus a column capacitance (i.e., an adjacent line capacitance) is also formed between adjacent first electrodes 222.

The plurality of second electrodes 224 are divided into a plurality of transmit (TX) second electrodes 224TX and a plurality of receive (RX) second electrodes 224RX. The transmit (TX) second electrodes 224TX and receive (RX) second electrodes 224RX extend in the second direction (for example, the horizontal direction) parallel to each other. The transmit (TX) second electrodes 224TX and receive (RX) second electrodes 224RX are interleaved such that, except for end electrodes, each receive (RX) second electrodes 224RX is positioned between a pair of transmit (TX) second electrodes 224TX and each transmit (TX) second electrode 224TX is positioned between a pair of receive (RX) second electrodes 224RX, and thus a row capacitance (i.e., an adjacent line capacitance) is also formed between adjacent second electrodes 124.

The touch screen circuit 230 includes a plurality of transmit drive circuits 232 and a plurality of receive sense circuits 234. The outputs of the transmit drive circuits 232 are coupled to the transmit (TX) first electrodes 222TX and transmit (TX) second electrodes 224TX, while the inputs of the receive sense circuits 234 are coupled to the receive (RX) first electrodes 222RX and receive (RX) second electrodes 224RX. Sensing of the touch screen panel 220 is performed by scanning rows and columns of panel to sense capacitance. This is accomplished by activating one of the transmit drive circuits 232 and one of the receive sense circuits 234 whose corresponding transmit electrode and receive electrode are adjacent to each other in the panel. The sensed adjacent line capacitance at a row or column is varied under the influence of a touch made to (or near) the panel 220. The scanning operation is repeated as needed such that each row and column is scanned within the panel 220, and the sensed capacitance values are resolved to calculate the X and Y coordinates of the touch.

The plurality of transmit (TX) first electrodes 222TX are divided into sub-groups each containing a plurality of first electrodes 222. For example, two sub-groups may be defined as a first sub-group of transmit (TX) first electrodes 222TX1 and a second sub-group of transmit (TX) first electrodes 222TX2.

The plurality of transmit (TX) second electrodes 224TX are divided into sub-groups each containing a plurality of second electrodes 224. For example, two sub-groups may be defined as a first sub-group of transmit (TX) second electrodes 224TX1 and a second sub-group of transmit (TX) second electrodes 224TX2.

The electrodes for the first sub-group of transmit (TX) first electrodes 222TX1 are group coupled to the output of a first transmit drive circuit 232(1). The electrodes for the first sub-group of transmit (TX) second electrodes 224TX1 are group coupled to the output of a second transmit drive circuit 232(2). The electrodes of the second sub-group of transmit (TX) first electrodes 222TX2 are individually coupled to the outputs of corresponding ones of the drive circuits 232 (in the example, drive circuits 232(3) and 232(4)). The electrodes of the second sub-group of transmit (TX) second electrodes 224TX2 are individually coupled to the outputs of corresponding ones of the drive circuits 232 (in the example, drive circuits 232(5) and 232(6)).

It will accordingly be understood that one-half of the transmit (TX) first electrodes 222TX are group coupled to the output of the first transmit drive circuit 232(1) and the other half of the transmit (TX) first electrodes 122TX are individually coupled to the outputs of corresponding second transmit drive circuits 232. Likewise, one-half of the transmit (TX) second electrodes 224TX are group coupled to the output of the second transmit drive circuit 232(2) and the other half of the transmit (TX) second electrodes 224TX are individually coupled to the outputs of corresponding transmit drive circuits 232. The reference to “one-half” above will be understood to mean exactly one-half or approximately one-half, wherein approximately one-half occurs when there exist an odd number of rows or columns (i.e., n/2 for the one half and n/2+1 for the other half, where n is the number of rows or columns).

In a preferred implementation, the electrodes of the plurality of receive (RX) first electrodes 222RX are individually coupled to the inputs of corresponding individual ones of the plurality of receive sense circuits 234. Likewise, the electrodes of the plurality of receive (RX) second electrodes 224RX are individually coupled to the inputs of corresponding individual ones of the plurality of receive sense circuits 234. If the touch screen circuit 230 includes an insufficient number of receive sense circuits 234 to handle the unique coupling to the plurality of receive (RX) first electrodes 222RX and the plurality of receive (RX) second electrodes 224RX, a multiplexing circuit 240 (optional) can be added to allow the receive (RX) first electrodes 222RX and receive (RX) second electrodes 224RX to share a set of receive sense circuits 234.

An example of a suitable touch screen processing circuit 230 for use with the projected capacitive touch screen panel 220 is the STM8T family of microcontrollers produced by STMicroelectronics, for example, the STM8TL53 microcontroller. This microcontroller includes a plurality of transmit drive circuits 232 (for example, up to fifteen transmit channels) and a plurality of receive sense circuits 234 (for example, up to twenty receive channels). It will further be understood that the processing circuit 230 may be formed by more than one microcontroller. For example, a first microcontroller may be used for making the column measurements and a second microcontroller may be used for making the row measurements. One or the other of the microcontrollers, or perhaps a third microcontroller or processing circuit, could be used to process the row and column measurements to calculate the X and Y coordinates of the touch.

The microcontroller circuitry for the touch screen processing circuit 230 is programmed to implement a scanning algorithm to make the row and column scans, detect adjacent line capacitances associated with such scans, and process the detected capacitances to calculate the X and Y coordinates of the touch. The scanning operation supported by the algorithm may generally be described as follows:

For column scanning, the transmit drive circuits 232 associated with the transmit (TX) first electrodes 222TX are sequentially actuated and for each actuation in the sequence the receive sense circuits 234 for the receive (RX) first electrodes 222RX are actuated (perhaps sequentially) to make column adjacent line capacitance measurements. This operation may be understood as a nested loop operation with the selection of transmit (TX) first electrodes 222TX being made in the outer loop and the selection of receive (RX) first electrodes 222RX being made in the inner loop.

For row scanning, the transmit drive circuits 232 associated with the transmit (TX) second electrodes 224TX are sequentially actuated and for each actuation in the sequence the receive sense circuits 234 for the receive (RX) second electrodes 224RX are actuated (perhaps sequentially) to make row adjacent line capacitance measurements. This operation may be understood as a nested loop operation with the selection of transmit (TX) second electrodes 224TX being made in the outer loop and the selection of receive (RX) second electrodes 224RX being made in the inner loop.

The column adjacent line capacitance measurements and row adjacent line capacitance measurements are then processed to calculate the X and Y coordinates of the touch. This processing calculation operation is well known to those skilled in the art and will not be described in detail.

The column scanning operation, row scanning operation, and coordinate processing calculation may be performed by one microcontroller or by separate microcontrollers in accordance with a desired design of the processing circuit 230. The selection of the number of microcontrollers for inclusion in the processing circuit 230 may be made in response to the size of the panel and the number of included column electrodes 222 and row electrodes 224.

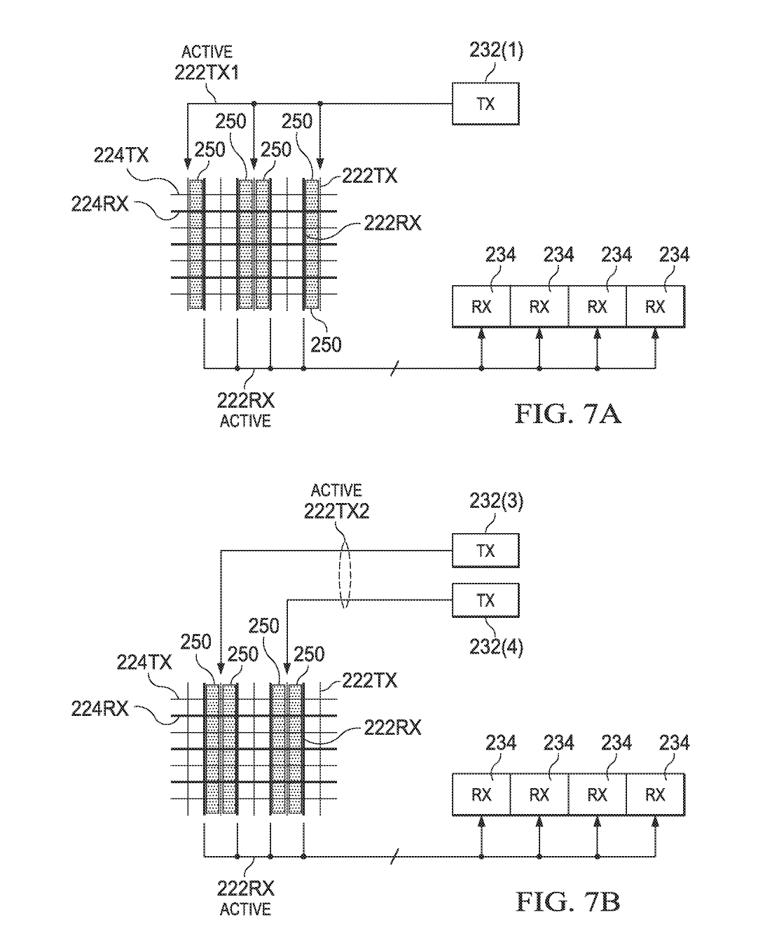

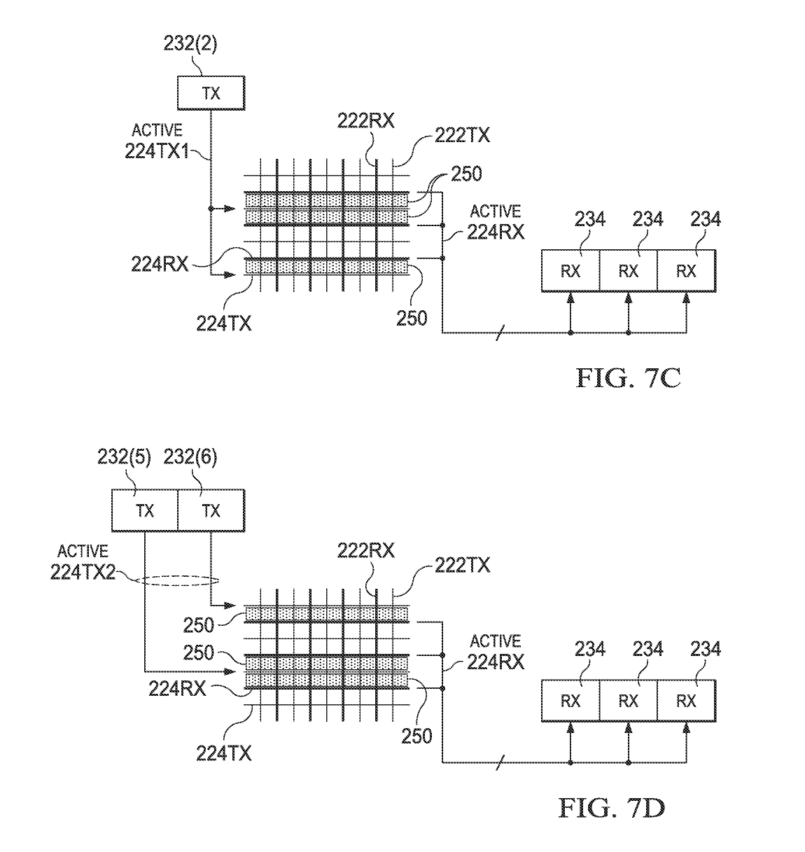

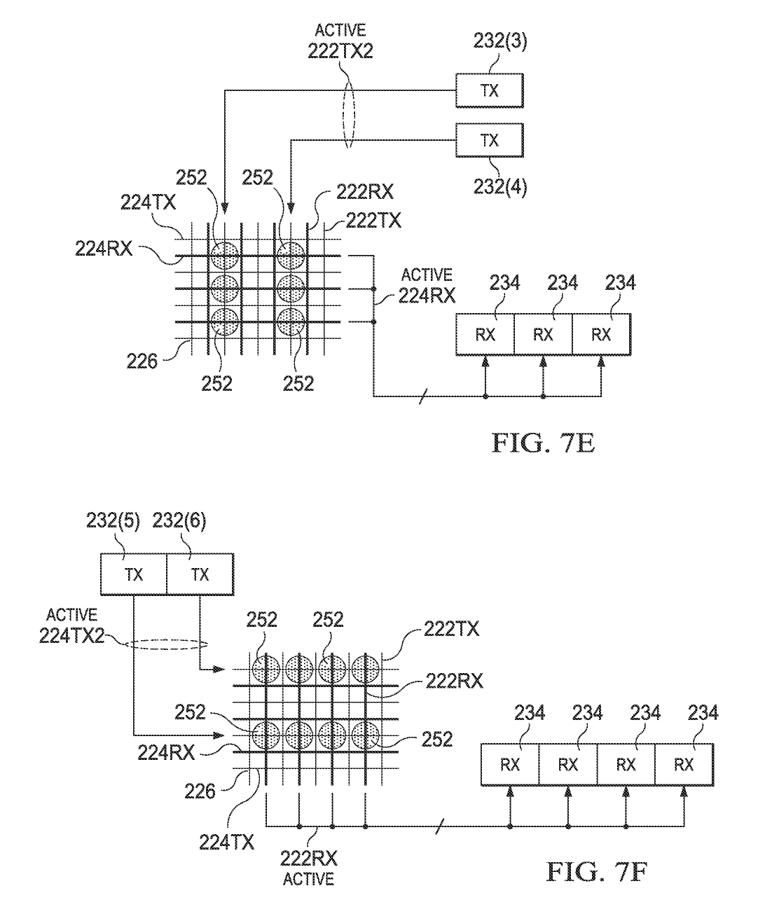

A better understanding of the scanning algorithm may be obtained by reference to a specific example. In FIG. 7A, transmit drive circuit 232(1) is activated and the first sub-group of transmit (TX) first electrodes 222TX1 is selected. The receive sense circuits 234 for the receive (RX) first electrodes 222RX are then actuated (preferably in parallel) to make column adjacent line capacitance measurements (as indicated by the shading 250). This would accordingly comprise the making of four (surface capacitive-like) measurements. The second sub-group of transmit (TX) first electrodes 222TX2 are controlled by the processing circuit 230 to be tied to a reference voltage (for example, ground) in order to address (i.e., reduce) concerns with cross-detection. The transmit (TX) second electrodes 224TX and receive (RX) second electrodes 224RX which cross the electrodes 222 are controlled by the processing circuit 230 to be floating.

In FIG. 7B, transmit drive circuits 232(3) and 232(4) are activated and the second sub-group of transmit (TX) first electrodes 222TX2 is selected. The receive sense circuits 234 for the receive (RX) first electrodes 222RX are then actuated (preferably in parallel) to make column adjacent line capacitance measurements (as indicated by the shading 250). This would accordingly comprise the making of four (surface capacitive-like) measurements. The first sub-group of transmit (TX) first electrodes 222TX1 are controlled by the processing circuit 230 to be tied to a reference voltage (for example, ground) in order to address (i.e., reduce) concerns with cross-detection. The transmit (TX) second electrodes 224TX and receive (RX) second electrodes 224RX which cross the electrodes 222 are controlled by the processing circuit 230 to be floating.

In FIG. 7C, transmit drive circuit 232(2) is activated and the first sub-group of transmit (TX) second electrodes 224TX1 is selected. The receive sense circuits 234 for the receive (RX) second electrodes 224RX are then actuated (preferably in parallel) to make row adjacent line capacitance measurements (as indicated by the shading 250). This would accordingly comprise the making of three (surface capacitive-like) measurements. The second sub-group of transmit (TX) second electrodes 224TX2 are controlled by the processing circuit 230 to be tied to a reference voltage (for example, ground) in order to address (i.e., reduce) concerns with cross-detection. The transmit (TX) first electrodes 222TX and receive (RX) first electrodes 222RX which cross the electrodes 224 are controlled by the processing circuit 230 to be floating.

In FIG. 7D, transmit drive circuits 232(5) and 232(6) are activated and the second sub-group of transmit (TX) second electrodes 224TX2 is selected. The receive sense circuits 234 for the receive (RX) second electrodes 224RX are then actuated (preferably in parallel) to make row adjacent line capacitance measurements (as indicated by the shading 250). This would accordingly comprise the making of three (surface capacitive-like) measurements. The first sub-group of transmit (TX) second electrodes 224TX1 are controlled by the processing circuit 230 to be tied to a reference voltage (for example, ground) in order to address (i.e., reduce) concerns with cross-detection. The transmit (TX) first electrodes 222TX and receive (RX) first electrodes 222RX which cross the electrodes 224 are controlled by the processing circuit 230 to be floating.

The operation of FIG. 7A-7D is accordingly substantially identical to the operation of FIGS. 4A-4D. At this point, it is understood that the system 210 suffers from the same issue as the system 110 with respect to being able to identify and distinguish between multiple touches simultaneously made to the panel 220. The system 210 differs from the system 110 in the connection of the electrodes within the second sub-group of transmit (TX) first electrodes 222TX2 to individual transmit drive circuits 232(3) and 232(4) and the connection of the electrodes within the second sub-group of transmit (TX) second electrodes 224TX2 to individual transmit drive circuits 232(5) and 232(6). These connections, along with appropriate scanning actions taken under the control of the processing circuit 230, permit the system 210 to make multiple touch detections.

The scanning operation supported by the algorithm may further be described to implement selected projected capacitive touch sensing between rows and columns as follows:

Individual ones of the electrodes within the second sub-group of transmit (TX) first electrodes 222TX2 (for columns) are actuated and for each actuation the receive sense circuits 234 for the receive (RX) second electrodes 224RX (for rows) are sequentially actuated to make intersecting line capacitance measurements at certain ones of the individual locations 226 on the panel 220.

Individual ones of the electrodes within the second sub-group of transmit (TX) second electrodes 224TX2 (for rows) are actuated and for each actuation the receive sense circuits 234 for the receive (RX) first electrodes 222RX (for columns) are sequentially actuated to make intersecting line capacitance measurements at certain ones of the individual locations 226 on the panel 220.

The column adjacent line capacitance measurements, row adjacent line capacitance measurements and individual location intersecting line capacitance measurements are then processed to calculate the X and Y coordinates of the one or more touches. This processing calculation operation is well known to those skilled in the art and will not be described in detail.

The column scanning operation, row scanning operation, location scanning operation and coordinate processing calculation may be performed by one microcontroller or by separate microcontrollers in accordance with a desired design of the processing circuit 230. The selection of the number of microcontrollers for inclusion in the processing circuit 230 may be made in response to the size of the panel and the number of included column electrodes 222 and row electrodes 224.

A better understanding of the selected projected capacitive touch portion of the scanning algorithm may be obtained by reference to a specific example.

In FIG. 7E, the transmit drive circuits 232(3) and 232(4) are sequentially activated and individual electrodes 222 within the second sub-group of transmit (TX) first electrodes 222TX2 are correspondingly selected. For each electrode 222 selection, the receive sense circuits 234 for the receive (RX) second electrodes 224RX are sequentially actuated to make location 226 intersecting line capacitance measurements (as indicated by the shading 252). This would accordingly comprise the making of six (projected capacitance) measurements. The first sub-group of transmit (TX) first electrodes 222TX1, the first sub-group of transmit (TX) second electrodes 224TX1 and the receive (RX) first electrodes 222RX are controlled by the processing circuit 230 to be tied to a reference voltage (for example, ground) in order to address (i.e., reduce) concerns with cross-detection.

In FIG. 7F, the transmit drive circuits 232(5) and 232(6) are sequentially activated and individual electrodes 224 within the second sub-group of transmit (TX) second electrodes 224TX2 are correspondingly selected. For each electrode 224 selection, the receive sense circuits 234 for the receive (RX) first electrodes 222RX are sequentially actuated to make location 226 intersecting line capacitance measurements (as indicated by the shading 252). This would accordingly comprise the making of eight (projected capacitance) measurements. The first sub-group of transmit (TX) first electrodes 222TX1, the first sub-group of transmit (TX) second electrodes 224TX1 and the receive (RX) second electrodes 224RX are controlled by the processing circuit 230 to be tied to a reference voltage (for example, ground) in order to address (i.e., reduce) concerns with cross-detection. It will accordingly be noted that this example requires the making of (X−1)+(Y−1) adjacent line sense measurements (reference 250) and (X−1)+(Y−1) intersecting line sense measurements (reference 252) to scan the entire panel (where X is the number of vertical electrodes 222 and Y is the number of horizontal electrodes 224). This is still significantly less than the X·Y scanning operations that must be performed in the conventional projected capacitive touch screen process in order to completely scan all intersection locations 226 of the touch screen panel 220. Thus, even if the size of the panel 220 is significantly large, the process illustrated in FIG. 7A-4F will provide a substantial improvement in acquisition time.

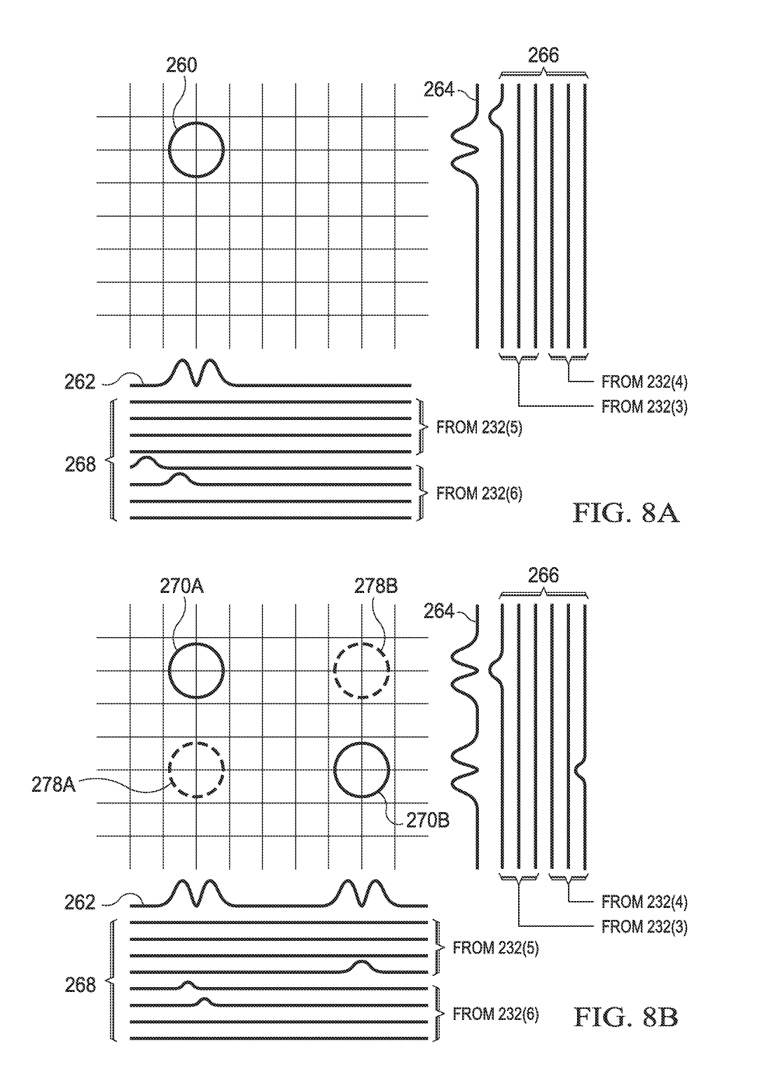

FIG. 8A illustrates a touch 260 having been made to the panel 220. The results of the FIGS. 7A-7B column adjacent line capacitance measurements are illustrated by waveform 262 which peaks along the x-axis (horizontal direction) at a size and location corresponding to the surface capacitive measurements (between adjacent electrodes) associated with the horizontal (X coordinate) of the touch 260. The results of the FIGS. 7C-7D row adjacent line capacitance measurements are illustrated by waveform 264 which peaks along the y-axis (vertical direction) at a size and location corresponding to the surface capacitive measurements (between adjacent electrodes) associated with the vertical (Y coordinate) of the touch 260. The results of the FIG. 7E location intersecting line capacitance measurements are illustrated by the waveforms 266 which include one waveform (associated with the activation of transmit driver circuit 232(3)) that peaks along the y-axis (vertical direction) at a location corresponding to the projected capacitive measurement (between intersecting electrodes) associated with the vertical (Y coordinate) of the touch 260. The results of the FIG. 7F location intersecting line capacitance measurements are illustrated by the waveforms 268 which include two waveforms (associated with the activation of transmit driver circuit 232(6)) that peak along the x-axis (horizontal direction) at a location corresponding to the projected capacitive measurement (between intersecting electrodes) associated with the horizontal (X coordinate) of the touch 260. The waveforms 262, 264, 266 and 268 may accordingly be processed to calculate the X and Y coordinates of the touch (it being understood that with a single touch 260 only the waveforms 262 and 264 are needed to make the coordinate calculation, and the waveforms 266 and 268 confirm the existence of a single touch).

FIG. 8B illustrates simultaneous touches 270A and 270B having been made to the panel 220. The results of the FIGS. 7A-7B column adjacent line capacitance measurements are illustrated by waveform 272 which peaks along the x-axis (horizontal direction) at a size and location corresponding to the surface capacitive measurements (between adjacent electrodes) associated with the horizontal (X coordinate) of the two touches 270A and 270B. The results of the FIGS. 7C-7D row adjacent line capacitance measurements are illustrated by waveform 274 which peaks along the y-axis (vertical direction) at a size and location corresponding to the surface capacitive measurements (between adjacent electrodes) associated with the vertical (Y coordinate) of the two touches 270A and 270B. As discussed above, the waveforms 272 and 274 cannot be processed to calculate the X and Y coordinates of the two touches 270A and 270B because the multiple peaks in the waveforms 262 and 264 could alternatively indicate touches being made at ghost locations 278A and 278B. The results of the FIG. 7E location intersecting line capacitance measurements are illustrated by the waveforms 266 which include one waveform (associated with the activation of transmit driver circuit 232(3)) that peaks along the y-axis (vertical direction) at a location corresponding to the projected capacitive measurement (between intersecting electrodes) associated with the vertical (Y coordinate) of the touch 270A and another waveform (associated with the activation of transmit driver circuit 232(4)) that peaks along the y-axis (vertical direction) at a location corresponding to the projected capacitive measurement (between intersecting electrodes) associated with the vertical (Y coordinate) of the touch 270B. The results of the FIG. 7F location intersecting line capacitance measurements are illustrated by the waveforms 268 which include one waveform (associated with the activation of transmit driver circuit 232(5)) that peaks along the x-axis (horizontal direction) at a location corresponding to the projected capacitive measurements (between intersecting electrodes) associated with the horizontal (X coordinate) of the touch 270B and two waveforms (associated with the activation of transmit driver circuit 232(6)) that peak along the x-axis (horizontal direction) at a location corresponding to the projected capacitive measurements (between intersecting electrodes) associated with the horizontal (X coordinate) of the touch 270A. The waveforms 262, 264, 266 and 268 may accordingly be processed to calculate the X and Y coordinates of the multiple touches.

It will accordingly be understood that projected capacitive touch screen system 110 of FIG. 6 is suitable only for both single touch and multi-touch applications.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

What is claimed is:

1. Apparatus, comprising:
a capacitive touch panel including a plurality of first electrodes extending in first direction and a plurality of second electrodes extending in a second direction, the first and second electrodes intersecting each other;
wherein the plurality of first electrodes includes transmit first electrodes and receive first electrodes, the transmit first electrodes and receive first electrodes being interleaved;
wherein the plurality of second electrodes includes transmit second electrodes and receive second electrodes, the transmit second electrodes and receive second electrodes being interleaved;
transmit circuitry coupled to the transmit first electrodes and transmit second electrodes; and
receive circuitry coupled to the receive first electrodes and receive second electrodes.

2. The apparatus of claim 1, wherein the transmit first electrodes are divided into a first sub-group of transmit first electrodes and a second sub-group of transmit first electrodes.

3. The apparatus of claim 2, wherein the transmit circuitry comprises a first transmitter having an output coupled to each of the first electrodes in the first sub-group of transmit first electrodes.

4. The apparatus of claim 3, wherein the receive circuitry comprises a plurality of receivers each having an input coupled to a corresponding one of the receive first electrodes.

5. The apparatus of claim 4, further comprising a processing circuit configured to: activate the first transmitter, activate the plurality of receivers, and sense adjacent line capacitance between first electrodes of the first sub-group of transmit first electrodes and adjacent ones of the receive first electrodes.

6. The apparatus of claim 5, wherein the processing circuit is further configured to process the sensed adjacent line capacitance to determine a coordinate of a touch made to or near the capacitive touch panel.

7. The apparatus of claim 4, wherein the transmit circuitry comprises a second transmitter having an output coupled to each of the first electrodes in the second sub-group of transmit first electrodes.

8. The apparatus of claim 7, further comprising a processing circuit configured to: activate the first transmitter, activate the plurality of receivers, sense adjacent line capacitance between first electrodes of the first sub-group of transmit first electrodes and adjacent ones of the receive first electrodes, activate the second transmitter, activate the plurality of receivers, and sense adjacent line capacitance between first electrodes of the second sub-group of transmit first electrodes and adjacent ones of the receive first electrodes.

9. The apparatus of claim 8, wherein the processing circuit is further configured to process the sensed adjacent line capacitance to determine a coordinate of a touch made to or near the capacitive touch panel.

10. The apparatus of claim 4, wherein the transmit circuitry comprises a plurality of second transmitters each having an output coupled to a corresponding one of first electrodes in the second sub-group of transmit first electrodes.

11. The apparatus of claim 10,
wherein the receive circuitry comprises an additional plurality of receivers each having an input coupled to a corresponding one of the receive second electrodes;
further comprising a processing circuit configured to: activate the second transmitters, activate the plurality of additional receivers, and sense intersecting line capacitance between first electrodes of the second sub-group of transmit first electrodes and intersecting ones of the receive second electrodes.

12. The apparatus of claim 11, wherein the processing circuit is further configured to process the sensed intersecting line capacitance to determine a coordinate of a touch made to or near the capacitive touch panel.

13. A method, comprising:
controlling operation of a capacitive touch panel including a plurality of first electrodes extending in first direction and a plurality of second electrodes extending in a second direction, the first and second electrodes intersecting each other;
wherein the plurality of first electrodes includes transmit first electrodes and receive first electrodes, the transmit first electrodes and receive first electrodes being interleaved;
wherein the plurality of second electrodes includes transmit second electrodes and receive second electrodes, the transmit second electrodes and receive second electrodes being interleaved;
wherein controlling comprises:
activating transmit circuitry coupled to the transmit first electrodes and transmit second electrodes; and
activating receive circuitry coupled to the receive first electrodes and receive second electrodes.

14. The method of claim 13, wherein the transmit first electrodes are divided into a first sub-group of transmit first electrodes and a second sub-group of transmit first electrodes, and wherein activating transmit circuitry comprises activating a first transmitter having an output coupled to each of the first electrodes in the first sub-group of transmit first electrodes.

15. The method of claim 14, wherein the receive circuitry comprises a plurality of receivers each having an input coupled to a corresponding one of the receive first electrodes; and wherein activating receive circuitry comprises activating the plurality of receivers, the method further comprising: sensing adjacent line capacitance between first electrodes of the first sub-group of transmit first electrodes and adjacent ones of the receive first electrodes.

16. The method of claim 15, further comprising processing the sensed adjacent line capacitance to determine a coordinate of a touch made to or near the capacitive touch panel.

17. The method of claim 14, wherein activating transmit circuitry comprises activating a second transmitter having an output coupled to each of the first electrodes in the second sub-group of transmit first electrodes.

18. The method of claim 17, wherein the receive circuitry comprises a plurality of receivers each having an input coupled to a corresponding one of the receive first electrodes; and wherein activating receive circuitry comprises activating the plurality of receivers, the method further comprising: sensing adjacent line capacitance between first electrodes of the second sub-group of transmit first electrodes and adjacent ones of the receive first electrodes.

19. The method of claim 18, further comprising processing the sensed adjacent line capacitance to determine a coordinate of a touch made to or near the capacitive touch panel.

20. The method of claim 14, wherein activating transmit circuitry comprises activating a plurality of second transmitters each having an output coupled to a corresponding one of first electrodes in the second sub-group of transmit first electrodes.

21. The method of claim 20, wherein the receive circuitry comprises a plurality of receivers each having an input coupled to a corresponding one of the receive second electrodes; and wherein activating receive circuitry comprises activating the plurality of receivers, the method further comprising: sensing intersecting line capacitance between first electrodes of the second sub-group of transmit first electrodes and intersecting ones of the receive second electrodes.

22. The method of claim 21, further comprising processing the sensed intersecting line capacitance to determine a coordinate of a touch made to or near the capacitive touch panel.
